(19) United States
(12) Patent Application Publication
(10) Pub. No.: US 2003/0051353 A1
(43) Pub. Date: Mar. 20, 2003

(54) Formation of a disk from a fracturable material

(76) Inventors: Andreas Gartner, Melbourne, FL (US); Anthony Pappalardo, Palm Bay, FL (US)

Correspondence Address: Andreas Gartner and Anthony Pappalardo, ACA Precision Technology, Inc., 4450-L Enterprise Court, Melbourne, FL, 32934, US

(21) Appl. No.: 10/210,617

(22) Filed: Aug. 1, 2002

Related U.S. Application Data
(63) Continuation-in-part of application No. 09/782,465, filed on Feb. 13, 2001, now abandoned.

(51) Int. Cl. B43L 13/00

(52) U.S. Cl. 33/18.1

(57) ABSTRACT

A method for separating a shaped body from a substrate, the method comprising forming a scoreline having a width and a depth in a first side of the substrate in a directional path defining the annular shaped body from the substrate, applying a temperature differential to at least one of the annular shaped body and the main body to increase the width and the depth of the scoreline, and applying a physical force to separate the shaped body from the substrate.

### SPECIFIC DATA RELATED TO THE INVENTION

This application is a continuation-in-part of U.S. non-provisional application, Serial No. 09/782,465, filed Feb. 13, 2001.

### BACKGROUND OF THE INVENTION

The invention relates to glass disk substrates, and more particular to a method and apparatus for forming a round, elliptical, or annular shape glass disk body.

Presently, substrates made from fracturable materials are mainly scribed or scored by mechanical means and broken by application of a bending moment as apparently taught by DeTorre, U.S. Pat. No. 4,109,841. This bending moment acts along the linear scribeline or scoreline. Derivatives of such methodology have apparently been applied to almost all fracturable materials, for example, to plastic by Insolio, et al., U.S. Pat. No. 4,009,813 and to silicon wafers by Pote, et al., U.S. Pat. No. 4,247,031. Abel, U.S. Pat. No. 4,428,518, appears to teach a similar method that is applied to non-linear geometries as well as narrow elongated strips of glass. Maltby, Jr. et al., U.S. Pat. No. 4,454,972, appears to illustrate concerns about the edge quality and teaches a method for partially fracturing linear cuts in glass to facilitate subsequent severance of the body along the score line. McGuire, et al., U.S. Pat. No. 5,040,342, appears to introduce a subsequent grinding step to clean up the edges, whereas Bando, U.S. Pat. No. 5,888,268, and Lisec, U.S. Pat. No. 5,857,603, appears to teach industrial embodiments of the “break by bending moment” approach. Tani, et al., U.S. Pat. No. 5,250,339, apparently discloses a magnetic recording media made of glass, although without describing the manufacturing of the annular shaped platter itself. Sono, et al., U.S. Pat. No. 5,268,071, also apparently teaches aspects of a platter manufacturing process, describing the necessity of pristine edges on the raw platters. Hayashi, U.S. Pat. No. 5,569,518, appears to measure the impact of microscopic cracks to the stability of hard disk platters. Hagan, U.S. Pat. No. 5,643,649, appears to teach a method to improve the flatness of glass disk substrates, whereas Kitayama, et al., U.S. Pat. No. 5,725,625 and U.S. Pat. No. 5,916,656, appear to disclose methods to strengthen a substrate to circumvent problems arising from cracks or other surface/edge irregularities

The present production method currently applied in industry for annular shaped bodies as used in the hard disk industry foresees the mechanical scribing or scoring on a position outside the nominal outer diameter (OD) and inside the nominal inner diameter (ID) and a relatively crude breaking operation, which does not particularly take care of edge qualities as the breaking operation is succeeded by a grinding operation which takes the ID and/or OD back to nominal dimension and removes cracks or chipping from the preceding manufacturing step. The disadvantage of this method is that the costs of an industrial grinding step are relatively high and demand sizable efforts in the final inspection of the part due to tool wear on part of the grinding heads. Furthermore, as the grinding operation itself introduces cracks, though smaller than the one left by mechanical scribing or scoring, a further step is needed, edge polishing, to guarantee that the platter can be spun up to 15,000 revolutions per minute (rpm) as required in modern drives.

### BRIEF DESCRIPTION OF THE INVENTION

The present invention is directed to a method and system for forming a shaped body, typically circular or oval shaped, from a substrate where an opening in the center of the shaped body is formed. In one preferred embodiment, to separate the shaped body from the substrate, a scoreline having a width and a depth in a first side of the substrate in a directional path defining the annular shaped body from the substrate is formed. A temperature differential is applied to either the annular shaped body or the substrate to increase the width and the depth of the scoreline. A physical force is applied to separate the shaped body from the substrate.

In another preferred embodiment, to create a shaped opening in the shaped body, a scoreline in the shaped body to define the annular shape body from a material inside of the scoreline is formed. A temperature differential is applied to either an area outside of the scoreline or the material inside of the scoreline. Either a gravity pull or an ejection force is applied to the material inside of the scoreline to remove it.

An apparatus for forming the shaped body out of the substrate is also disclosed. The shaped body is defined by a scoreline(s). A force applicator is used to remove the annular shaped body from the substrate. A temperature differential device is applied for varying the temperature of either the substrate or the annular shaped body. As with the methods disclosed above, the temperature differential device produces either heat or cold. A substrate holder is used to hold the substrate in place. In one embodiment, the substrate holder is used just to hold the shaped body in place after the outer substrate has been removed and the final step of removing the material inside of an inner diameter scoreline is performed. A deflection device is provided to deflect either the annular shaped body or the substrate to assist in removing the material from within the ID. In another embodiment, the substrate holder is used to hold the substrate/shaped body as either heat or cold is applied.

### BRIEF DESCRIPTION OF DRAWINGS

The features of the invention are set forth with particularity in the appended claims. The invention itself, both as to organization and method of operation, may best be understood by reference to the following description in conjunction with the accompanying drawings in which like numbers represent like parts throughout the drawings and in which:

FIG. 1 is an exemplary illustration of a force applicator used to deepen and widen a scoreline throughout the entire material thickness;

FIG. 2 is an exemplary illustration of a heating element used to deepen and widen a scoreline;

FIG. 3 is an exemplary illustration of a cooling chamber used to cool material within an ID;

FIG. 4 is an exemplary illustration of a substrate holder comprising a heater element;

FIG. 5 is an exemplary illustration of a high speed and impulse force impacter to remove material within an ID of a shaped body; and

FIG. 6 is an exemplary illustration of deflecting and heating the main body before ejecting the material confined inside the scoreline.

### DETAILED DESCRIPTION OF THE INVENTION

With reference to the figures, exemplary embodiments of the invention will now be described. The scope of the invention disclosed is applicable to a plurality of bodies formed from a larger substrate or body. Thus, even though embodiments are described specific to disks made from fracturable material, such as glass, one skilled in the art will recognize how the invention is also applicable to other components having to be extracted from a larger substrate.

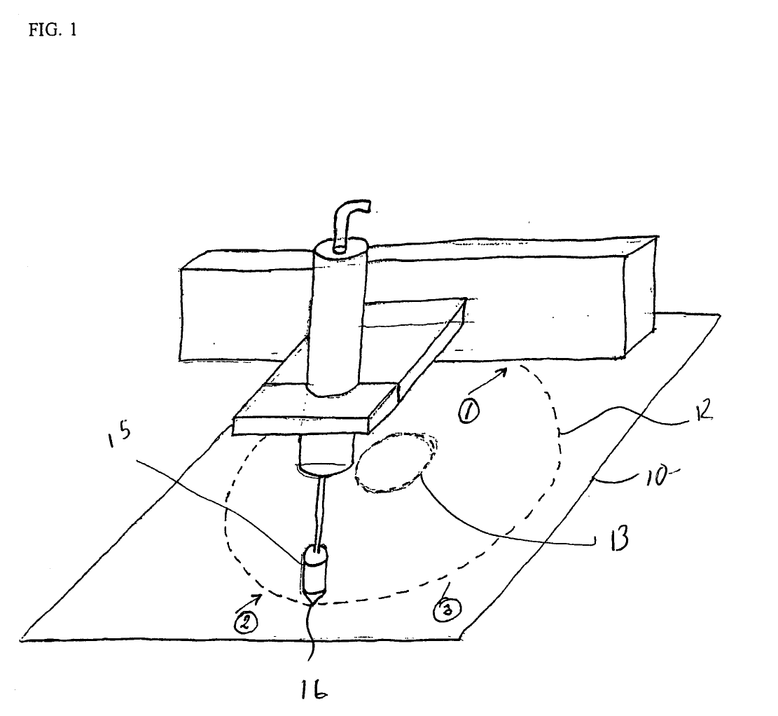

FIG. 1. Illustrates an exemplary use of a force applicator to deepen and widen a scoreline throughout the entire material thickness. A non-metallic substrate 10, made from glass, glass-ceramics, or other fracturable substances has one or more scribelines or scorelines 12, 13 in either a round, elliptical, or annular configuration, defining a shaped body 30. The scoreline 12, 13 is a fracture line which in general does not exceed a depth of between 1 to 500 microns. Thus the ratio of scribe line or scoreline depth to the overall thickness of the substrate 10 is in general a ratio ranging between 1:2 to 1:100. In other words, there is a significant amount of material in the intended extension of the scoreline 12, 13, which has not been impacted by the mechanical or thermo-mechanical scribe operation. The fracture 12, 13 needs to be extended throughout the material, whereby special care is to be taken that such extension follows a straight path without resulting in steps, nicks or burrs.

In a preferred embodiment, a force applicator 15 is used to apply a force on the opposite side of the substrate from the side were the scoreline is located in the exact path or to the left or the right of the exact directional path of the scoreline 12, 13. For example, an attempt to protrude a fracture on sodalime glass of typical composition (approximately, 65 mass percent Silicon-dioxide, and 25 mass percent Sodium-oxide) requires a force applicator 15 shaped as a 110 degree tip 16, made from semi-soft material like Delrin, to be run on the opposite side of the scoreline 12, 13 approximately 300 microns outside an, for example, 25 mm inner diameter (ID) scoreline 30. Aluminosilikate glass requires the same tip geometry but with a main force axis to coincide with an ideal extension of the scoreline 12, 13. For closed geometries, such as round or elliptical shapes, it is important that the force is applied 180 degrees apart from the weakest point in the scoreline 12, 13. Typically, where the scoreline 12, 13 is started and subsequently ends approaching after 360 degrees of rotation, the depth is slightly higher than on every point along the circumference. The applied force works against the particular stiffness of the substrate 10 as supported by the substrate holder.

Therefore, in the selection of materials used to construct the substrate holders that is discussed later, the process can be adjusted to provide more “give” or allowing the substrate holder to absorb more of the force of the substrate by choosing a softer material. For example, a preferred embodiment uses Delrin for a semi-soft support, a 1 mm rubber sheet for soft support, and an aluminum plate for hard support. The amount of support needed will be based on the substrate material.

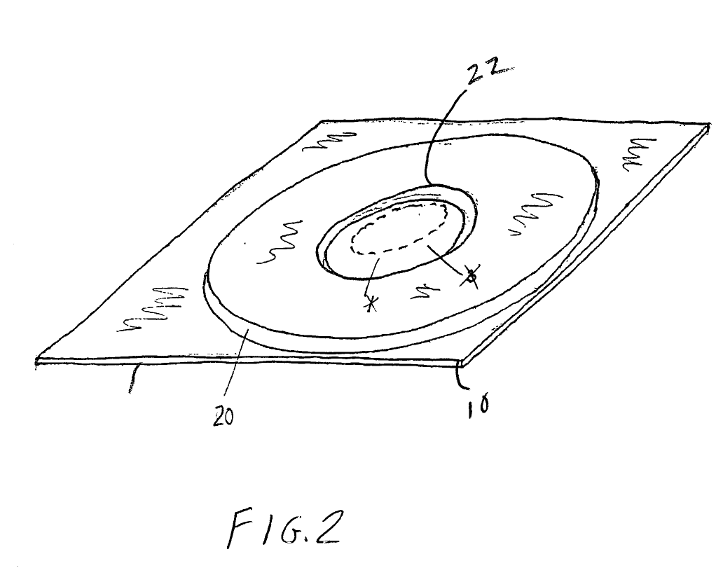

FIG. 2 is an illustration of an exemplary embodiment of a heating element used to deepen and widen a scoreline 12, 13. When exposing a substrate 10 with a scoreline 12, 13 to a heated surface for a certain amount of time, the sudden heat flux from the heated surface to the substrate effectively expands the substrate beyond the yield strength of the material in close vicinity to the scoreline. The scoreline 12, 13 opens, or protrudes from its initial depth throughout the entire depth of the material. In a typical embodiment an annular shaped heater element 20 is heated to a temperature, but not limited to, between 30 to 400 degree Celsius. The ID of the heater element 22 is larger than the ID scribed or scored 13 in the shaped body or substrate 10. As one skilled in the art will readily recognize, these embodiments can be used either before or after an outer diameter (OD) 12 has been separated from a substrate 10. Thus, substrate and shaped body can be used interchangeably. When the substrate 10, which is at ambient temperature, is placed in contact with the heated surface of the heater element 20 for a time between, but not limited to, 0.5 to 5 seconds, the scoreline opens while protruding through the entire thickness of the substrate 10. The center edge of the heater element 20 coincides with the substrate 10 to match the ID 22 of the heater element 20 with the scoreline in a concentric fashion. Similarly, though not shown, the substrate 10 with a scribed or scored OD 12 of a disk can be subjected to a heater element with a larger diameter OD than the one of the disk. Several other methods exist to provide momentary heat to a substrate, which will be obvious to a person skilled in the art.

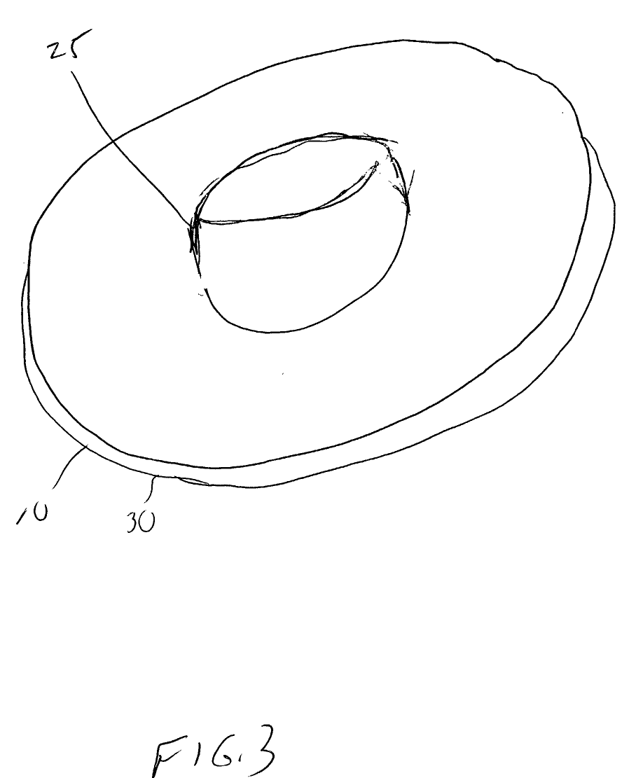

An alternate embodiment, for substrates sensitive to heat, is to cool the ID by means of a proper cooling device. In a preferred embodiment, not shown, the heating device and cooling device are one apparatus. In another preferred embodiment, illustrated in FIG. 3, a cylindrical chamber 25 filled with liquid Nitrogen, having an OD slightly smaller than the ID intended to open is used. The chamber 25 is filled with liquid Nitrogen and the substrate 10, or shaped body 30 with a scribed or scored ID 13 is made to contact a base place of the cylindrical chamber 25, whereby the center of the cylindrical face coincides with the center of the scoreline 13. It is preferred to submerge the entire apparatus, substrate and cylindrical chamber, in Nitrogen or Argon atmosphere (not shown) to avoid the formation of ice, from humidity in the air, on the cylindrical chamber and in particular on the face of the chamber. In a preferred embodiment, though not limited, the temperature of the base plate is between minus 195 to 0 degrees Celsius as a function of the time it takes a certain quantity of liquid Nitrogen to evaporate. Such sudden cooling of the material contained within the ID scribe line or scoreline 13 causes a contraction, which opens the scoreline throughout the entire thickness of the material.

The same method, though not shown, can be used on the OD of a disk or shaped body as well by using an annular shaped cooler assembly. The main annular body 30 is contracted whereas the surrounding material is not, effectively opening the scoreline. In another preferred embodiment, a forced stream of liquid Nitrogen or a similar alternate substance is applied to a surface which needs to be contracted. Alternate media or substances may be used for different temperature ranges, such as liquid air, dry ice, 2-Methyl butane, dry ice, acetone and other mixtures known in the art may used for cooling. In another preferred embodiment a combination of applying a temperature differential apparatus and a physical force apparatus are used.

In breaking or separating the shaped body 30 from the rest of the substrate 10, it is preferable to have a longer circumference of the scoreline, which will make it easier to separate. A preferred embodiment is to heat the surrounding material 10, or substrate until an expansion of, but not limited to, 5 to 50 microns is achieved and then to remove the shaped body 30 subsequently. As it is desirable to achieve perpendicular edges, the direction of removal is not important.

To achieve a tapered edge on the shaped body 30, either a sharp temperature gradient through the thickness of the material or a secondary scribe line or scoreline on the opposite side of the main scoreline, which is slightly smaller or larger than the main scoreline is applied. In general, the addition of a secondary scoreline on the opposite side does not improve the accuracy of the applying a force in terms of edge quality but can be used as a technique to form slightly tapered edges depending on the position of the secondary scribe relative to the position of the main scribe. The breaking of a tapered scribe line is dependent on the direction of removal and therefore the substrate orientation on the breaking assembly needs to account for the taper orientation.

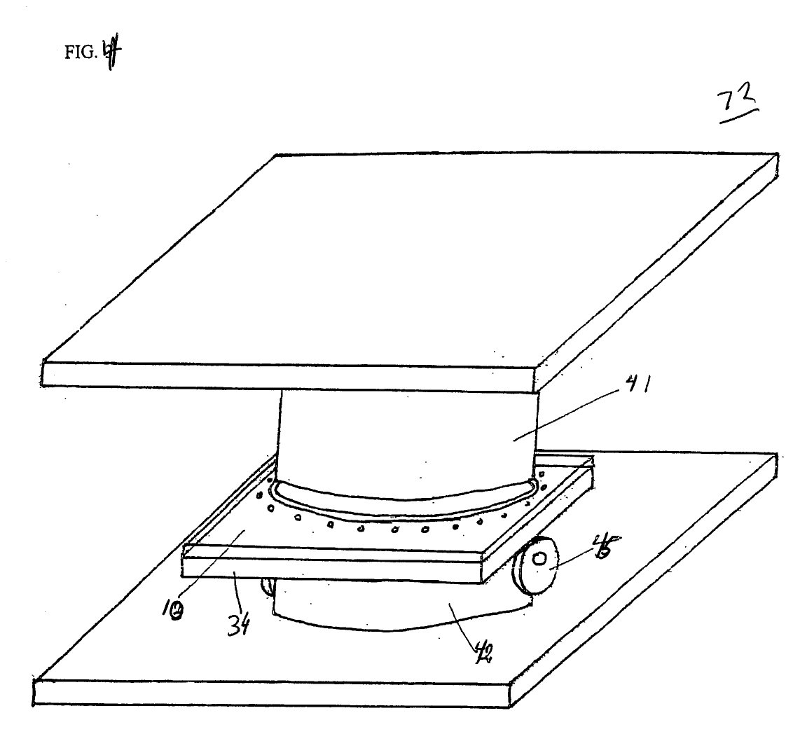

In a preferred embodiment, breaking the OD scoreline 12 consists of either a heater element 34 or any other source of heat, such as but not limited to heated air or a propane torch, capable of achieving a uniform heat distribution, focused to the material surrounding the OD. The temperature differential apparatus 34 heats the material outside the OD 10 until a gap of, but not limited to, 5 to 50 microns, depending on the material and edge geometry, has been achieved and subsequently lets gravity take over the moment a sufficient expansion has been achieved. Once heated, the main body 30 can be supported by an upper as well as lower support 41, 42, as illustrated in FIG. 4, not only to mechanically fix the position, but also to protect the main body from the heat destined to the surrounding material. This method is preferred over cooling the main body or shaped body 30 as the stress submitted to the main body 30 is held to a minimum. Nonetheless, for some material, the opposite method works best, or in other words, to cool the main body and remove the material surrounding the OD once a sufficient gap has formed. FIG. 4 also discloses a substrate holder 12 having a lifter cam 45 to elevate or lower the substrate outside of the OD once separated from the shaped body 30.

The material surrounding the OD scoreline is generally rectangular or square. Therefore, every point along the circumference of such a shaped substrate would have a different distance to the center of the part. If the body is supported along this perimeter in an attempt to break material inside of the ID from the body 30, a complex stress field would emerge duplicating the geometry of the circumference, which would impact the removal of the material inside of the ID as the expansion would not be uniform and binding occurs between the main body and the material inside the ID.

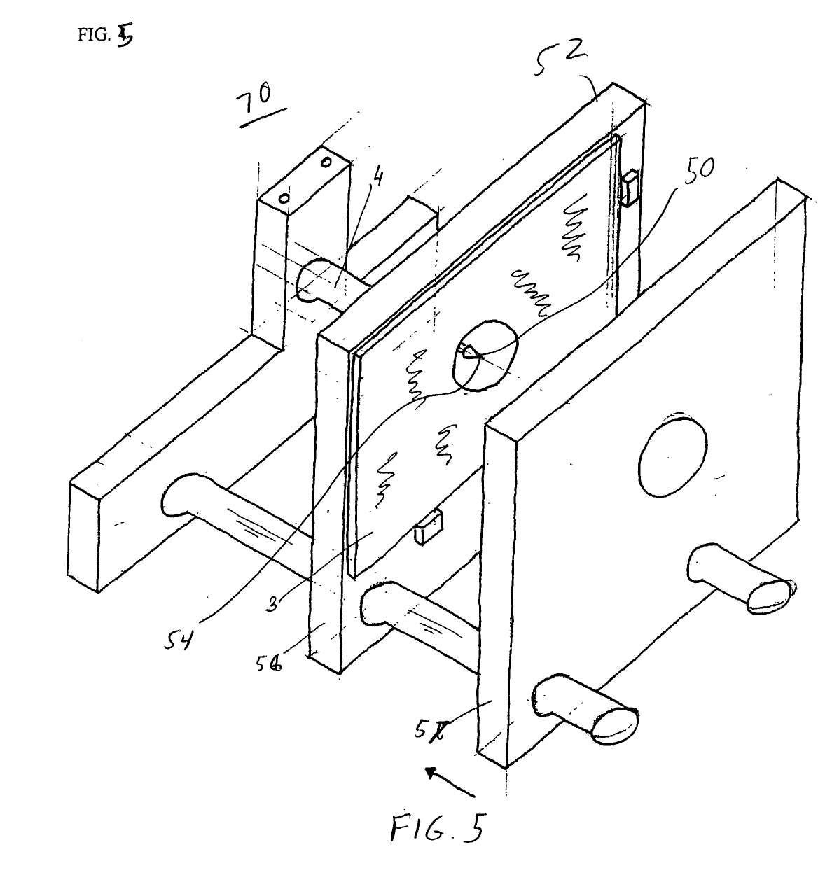

In one preferred embodiment, as illustrated in FIG. 5, to remove the material inside of the ID, the area of substrate within an ID can be destructed by a momentary force impulse device 50 toward a small area on the material inside of the ID, preferably in the center of the material inside of the ID. The shaped body 30 is held in place by a holder, or substrate holder 10, where the planer surface of the shaped body is in contact with the holder and the material inside the ID is not supported, or making contact with the substrate holder 52. In this embodiment, a hardened steel tip 54 with a tip diameter of several microns is accelerated towards the unsupported material inside the ID, while the main body 30 is supported by lower and upper (not shown) or left and right support chucks 56, 57. In a preferred embodiment, the steel tip 54 impacts the inner substrate within the ID with a speed between, but not limited to, 1 to 50 m/s. For example, sodalime glass of typical composition could use a speed of 23 m/s. For a person skilled in the art, it is obvious that a higher speed would be beneficial, but is accompanied by higher mechanical results that may be undesirable. Thus for higher speeds, reducing harm to the shaped body can be accompanied by deflecting the material inside the ID scoreline prior to impact. One way to deflect this material is by use of a vacuum. For harder glass substrates, such as alkaline earth silicates, or glass ceramics, a certain pre-stress on the material inside the ID by application of a vacuum is beneficial to the uniformity of results. In a preferred embodiment, the embodiment of FIGS. 4 and 5 are a single holder, where the features of both are combined into a single holder. This single holder can hold the substrate in a horizontal, vertical, or any position therebetween.

In another embodiment, an unexpanded ID scoreline is used where, depending on the scribe or scoring method used, there is virtually no gap between the main body and the material inside the ID. The metal tip 54 disclosed in FIG. 5 is positioned at the exact center of the ID scoreline.

In another preferred embodiment, the material inside the ID scoreline is cooled until a distinct gap forms between the shaped body and the material inside the ID. The material inside the ID is then ejected from within the ID by applying a uniformly applied force to avoid tilting. The uniform applied force could be a wider metal tip 54 disclosed in FIG. 5, where the surface which encounters the inside of the ID is a flat surface which has a diameter near or the same as the material inside of the ID, such as a cylinder. The gap necessary to cleanly eject the material inside the ID is, but is not limited to, 0.5 to 50 microns, depending on the characteristics of the material as well as the thickness of the substrate 10. Even a slight tilt of the cylinder would inevitably result in binding between the edges of the main to the cylindrical body. Such binding, when occurred, can be overcome by an increase in force, but leads to chipping and other effects along the edge of the main body, which we set out to avoid in first place.

Cooling of the material confined in the boundaries of the ID scoreline can be accomplished either with an assembly discussed previously, or a chamber type reservoir containing liquid nitrogen or another suitable coolant, which in turn is pressed to the surface of the material between the ID. It is important to provide uniform contact as otherwise the contraction does not have the same value in all directions. Preferably, with the same chamber face as used for cooling the material, it is in turn pushed out of the confinement of the shaped body. Again, submerging the entire apparatus in an inert atmosphere such as nitrogen helps to avoid the formation of snow on the chamber face, which mainly poses a problem in terms of the geometry while extracting the ID material.

In another preferred embodiment, heat is supplied to the shaped body, or disk, in order to expand the shaped body 30. Instead of conduction heating, using an indirect heat media such as heated air or other heated gaseous or even liquid media is preferred. In operation, the shaped body 30 is held along the circumference of the shaped body 30, where the OD scoreline 12 had been previously separated from a substrate 10. To avoid, or reduce, heat flux towards the material inside the ID such that a significant temperature difference occurs between main body 30 and material inside the ID, a tangential heat intake device makes contact with the material inside of the ID. A cone with it's base underneath the ID material (not shown) is used to provide additional absorption material where the heat flux is at least reduced in comparison to the heat flux in the main body 30. After a sufficient gap has formed due to the thermal expansion of the main body, such as but not limited to 0.5 to 50 microns, the material inside the ID is ejected by either gravity pull or by a mechanical force.

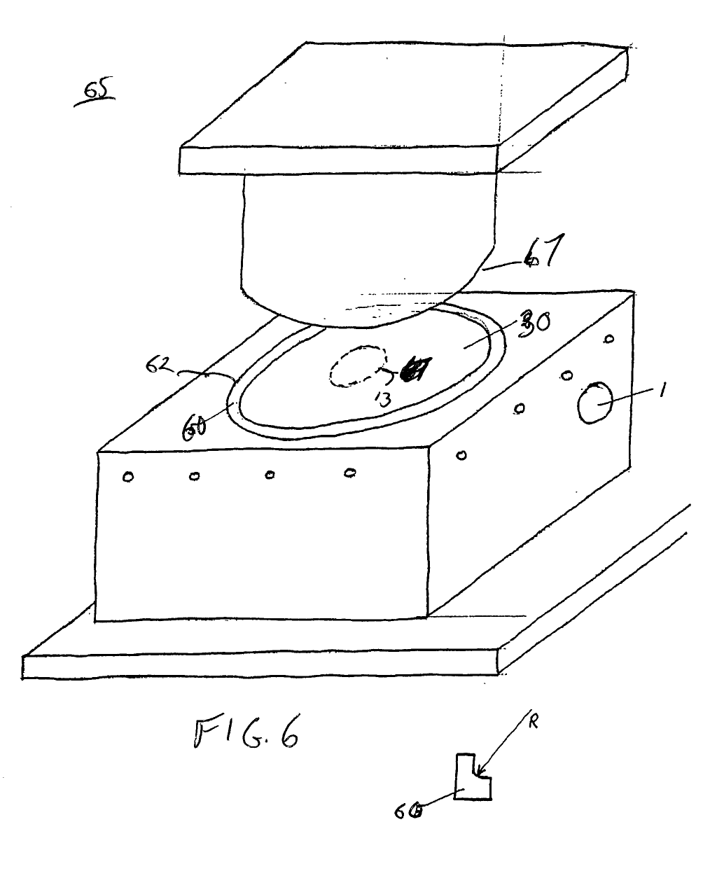

In another preferred embodiment, the shaped body 30 is held along the circumference of the OD in a substrate holder which mimics the shoulder arc of a sphere, as disclosed in FIG. 6. Without load, the shaped body 30 rests only on the lower edge 60 of the circumference and is held in position by vertical alignment supports 62 incorporated in the holder design 65. A member with a spherical face 67 is put in contact with the shaped body 30 to determine an un-deflected zero position and then moved in further against the holder to achieve a fully supported, controlled deflection of the shaped body 30. Due to this deflection, the lower side of the shaped body 30 in the vicinity of the OD circumference 12, makes full contact with the matching spherical radius of the support holder 26. The deflection rate is chosen as a function of the material characteristics and is mainly influenced by the stiffness and the Young's modulus. Deflection rates between 0 and 500 microns (on 95 mm OD and 25 mm ID) have been evaluated, but this invention is neither limited to this deflection range nor to the dimension of the main body which was given as an example.

When the desired deflection is achieved, a heat flux to the main body 30 is generated using the same methods as described above. A preferred embodiment is the use of heated air, as it is simple to control in terms of flow rate and temperature. Certainly this invention is not limited to air as media, as a person skilled in the art can easily substitute the media to achieve a different set of parameters in terms of thermal conductivity and heat capacity of the media. The same provisions apply to avoid or reduce the heat flux to the material inside the ID, whereby the use of a simple cone with it's base towards the material inside the ID, with a height of about one and a half times the material thickness underneath the substrate is sufficient to provide a temperature gradient of 100 to 150 degrees Celsius as long as the heating is done as rapidly as possible. For the typical substrate size of 95 mm OD heating to process temperatures is ideally accomplished within 5 to 10 seconds. When the main body 30 has expanded and a gap of between 0.5 and 50 microns formed, either gravity pull or a forced ejection by pressure air supplied by a provision in the spherical deflection plate is used to remove the ID material from the confinement of the main body.

The careful deflection of the main body 30 results in a cone-shaped gap which opens towards the lower side of the apparatus to facilitate the action of gravity or the forced ejection. In this embodiment the parallelism of the face of the cylindrical material to the face of the main body 30, or in this case tangent to the face while in deflection, is less critical as even when a slight tilt occurs the cone shape of the gap still provides ample, and increasing as a function of extraction progress, room to avoid edge chipping.

For glass and other materials with a defined temperature in excess of which every deformation becomes permanent it is important that the process temperature is chosen to never exceed this strain point. Therefore, after ejection of the material inside the ID, the deflection is taken back to zero and the heat flux is stopped. The annular shaped body such formed shows perfectly perpendicular edges without chipping on either side.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

What is claimed is:

1. A method for separating a shaped body from a substrate, the method comprising:
forming a scoreline having a width and a depth in a first side of the substrate in a directional path defining the annular shaped body from the substrate;
applying a temperature differential to at least one of the annular shaped body and the substrate to increase the width and the depth of the scoreline;
applying a physical force to separate the shaped body from the substrate.

2. The method of claim 1 wherein applying a temperature differential further comprises heating the substrate outside of the scoreline.

3. The method of claim 1 wherein applying a temperature differential further comprises cooling the shaped body inside of the scoreline.

4. The method of claim 1 wherein applying the physical force further comprising applying a gravitational pull.

5. The method of claim 1 wherein applying the physical force further comprising applying the physical force to a second side of the substrate, in the same directional path of the scoreline.

6. A method for creating a shaped opening in a shaped body, the method comprising:
forming a scoreline in the shaped body to define the annular shape opening from a material inside of the scoreline;
applying a temperature differential to at least one of an area outside of the scoreline and the material inside of the scoreline;
applying at least one of a gravity pull and an ejection force to the material inside of the scoreline.

7. The method of claim 6 wherein applying a temperature differential further comprises heating the shaped body outside of the scoreline.

8. The method of claim 6 wherein applying a temperature differential further comprises cooling the material inside of the scoreline.

9. The method of claim 6 further comprising removing the material inside the scoreline by impacting the material with an apparatus producing a momentary force impulse.

10. The method of claim 6 further comprising deflecting the shaped body to create a tapered gap.

11. An apparatus for forming a shaped body out of a substrate where the shaped body is defined by a scoreline, the apparatus comprising:
a force applicator to remove the substrate from the annular shaped body;
a temperature differential device for varying the temperature of at least one of the substrate and the annular shaped body;
a substrate holder;
a deflection device to deflect at least one of the annular shaped body and the substrate.

12. The apparatus of claim 11 wherein the force applicator applies a force on an opposite surface of the substrate containing the scoreline.

13. The apparatus of claim 11 wherein the substrate holder is made of a material wherein the material absorbs excess force applied by the force applicator depending on the material comprising the substrate.

14. The apparatus of claim 11 wherein the temperature differential device is an annular shaped heater element capable of heating at least one of the outer diameter substrate, the annular shaped body, and an annular piece to be removed from the annular shaped body.

15. The apparatus of claim 11 wherein the temperature differential device is a cooling device capable of cooling at least one of the annular shaped body and an annular piece to be removed from the annular shaped body.

16. The apparatus of claim 11 wherein the deflection device deflects at least one of the annular shaped body and an annular piece to be removed from the annular shaped body.

17. The apparatus of claim 11 wherein the deflection device is a device using a vacuum to cause a deflection.

18. The apparatus of claim 11 further comprising a momentary force impulse device for removing an annular piece from the annular shaped body defined by a scoreline.

19. The apparatus of claim 11 wherein the substrate holder is constructed of a material, which absorbs force of the force applicator away from the shaped body.

20. The apparatus of claim 11 further comprising a submersion tank for submerging at least one of the shaped body and the substrate in an inert atmosphere.
